(19) United States
(12) Patent Application Publication
(10) Pub. No.: US 2016/0253247 A1
(43) Pub. Date: Sep. 1, 2016

(54) METHOD AND DEVICE FOR RESTORING SYSTEM FILE INDEXES

(71) Applicant: STREAMAX TECHNOLOGY CO., LTD., Shenzhen (CN)

(72) Inventors: Kaiming HUANG, Shenzhen (CN); Jiye SUN, Shenzhen (CN); Xidian WANG, Shenzhen (CN)

(21) Appl. No.: 15/030,530

(22) PCT Filed: Dec. 1, 2014
(86) PCT No.: PCT/CN2014/092639

§ 371 Date: Apr. 19, 2016

(30) Foreign Application Priority Data
Oct. 10, 2014 (CN) 201410530985.9

(51) Int. Cl. G06F 11/14; G06F 17/30

(52) U.S. Cl. CPC G06F 11/1469; G06F 11/1451; G06F 17/30091; G06F 2201/80; G06F 2201/805; G06F 2201/84

(57) ABSTRACT

The present invention provides a method and device for restoring system file indexes, which belongs to the technical field of data store methods. In the present invention, when a storage medium is loaded and an index information set is not read, or when the storage medium is loaded and the indexes in the index information set are judged to be incorrect, or when a read operation is executed for a file in the storage medium and an index of the file in the index information set doesn't correspond to a backup index in the file, or when a writing operation is executed for a file in the storage medium and an index of the file in the index information set doesn't correspond to a backup index in the file, the backup indexes of all files in the storage medium are updated, and the index information set is restored or re-established. By using the method and device for restoring system file indexes of the present invention, a deficiency of repeated restarts without recording is overcome.

### TECHNICAL FIELD

The present application relates to the technical field of data storing methods, and more particularly, relates to a method and device for restoring system file indexes.

### BACKGROUND

Working mechanisms of general file systems have a common point: file management is implemented based on an index. In the operation process, index data is usually stored in an internal storage, and updating of the critical data is not synchronized into a storage medium in real time. When power outage occurs suddenly, it is too late to synchronize the index data in the internal storage into the storage medium, and thus the integrity of the index data of the general file system may be damaged.

When index information is damaged, although a corresponding record file actually exists in the storage medium, it is unable to read the record file, unless the index information is restored by using an offline tool. The record file losing an index thereof equates being deleted.

In case of damage of a critical index information of the file system, an upper application, such as a record storage program, has to be terminated when it, reads an abnormal value due to the absence of a corresponding processing flow, thereby generating a failure of repeated restarts without recording.

### BRIEF SUMMARY

The present application provides a method and device for restoring system file indexes, which have solved a deficiency of repeated restarts without recording.

In one aspect, the present invention provides a method for restoring system file indexes, the method comprises:

step A. when a storage medium is loaded, judging whether an index information set is read or not, if no, executing a step E, if yes, executing a step B;

step B. judging whether those indexes in the index information set are correct or not, if no, executing the step E;

step C. when executing a read operation for a first file in the storage medium, judging whether an index of the first file in the index information set corresponds to a backup index in the first file or not, if no, executing the step E;

step D. when executing a writing operation for a second file in the storage medium, judging whether an index of the second file in the index information set corresponds to a backup index in the second file or not, if no, executing the step E;

step E. updating backup indexes of all files in the storage medium, and restoring or re-establishing the index information set.

In a second aspect, the present invention provides a device for restoring system file index, which comprises:

a first judging module configured for judging whether an index information set is read or not when a storage medium is loaded;

a second judging module configured for judging whether indexes in the index information set are correct or not;

a third judging module configured for judging whether an index of a first file in the index information set corresponds to a backup index in the first file or not when executing a read operation for the first file in the storage medium;

a fourth judging module configured for judging whether an index of a second file in the index information set corresponds to a backup index in the second file or not when executing a writing operation for the second file in the storage medium; and

a restoring and re-establishing module configured for updating backup indexes of all files in the storage medium, and restoring or re-establishing the index information set.

In the embodiments of the present invention, the backup indexes of all files in the storage medium are updated and the index information set is restored or re-established when the storage medium is loaded and the index information set is not read, or when the storage medium is loaded and an index in the index information set is judged to be incorrect, or when a read operation is executed for a file in the storage medium and an index of the file in the index information set doesn't correspond to a backup index in the file, or when a writing operation is executed for the file in the storage medium and an index of the file in the index information set doesn't correspond to a backup index in the file. Thus, a deficiency of repeated restarts without recording is overcome.

### BRIEF DESCRIPTION OF THE DRAWINGS

In order to explain the embodiments of the present invention more clearly, a brief introduction regarding the accompanying drawings that need to be used for describing the embodiments is given below; it is obvious that the accompanying drawings described as follows are only some embodiments of the present invention, for those skilled in the art, other drawings can also be obtained according to the current drawings on the premise of paying no creative labor.

FIG. 1 illustrates one flow chart of a method for restoring system file indexes provided by a first embodiment of the present invention;

FIG. 2 illustrates another flow chart of a method for restoring system file indexes provided by the first embodiment of the present invention;

FIG. 3 illustrates a flow chart of a method for restoring system file indexes provided by a second embodiment of the present invention;

FIG. 4 illustrates one schematic structural diagram of a device for restoring system file indexes provided by a third embodiment of the present invention;

FIG. 5 illustrates another schematic structural diagram of a device for restoring system file index provided by the third embodiment of the present invention;

FIG. 6 illustrates one schematic structural diagram of a restoring module of a device for restoring system file indexes provided by the third embodiment of the present invention;

FIG. 7 illustrates another schematic structural diagram of a restoring module of a device for restoring system file indexes provided by the third embodiment of the present invention.

### DETAILED DESCRIPTION OF THE PREFERRED EMBODIMENT

In order to make the purpose, the technical features, and the advantages of the present invention be clearer, embodiments of the present invention will be further described in detail hereafter with reference to the accompanying drawings.

### Embodiment I

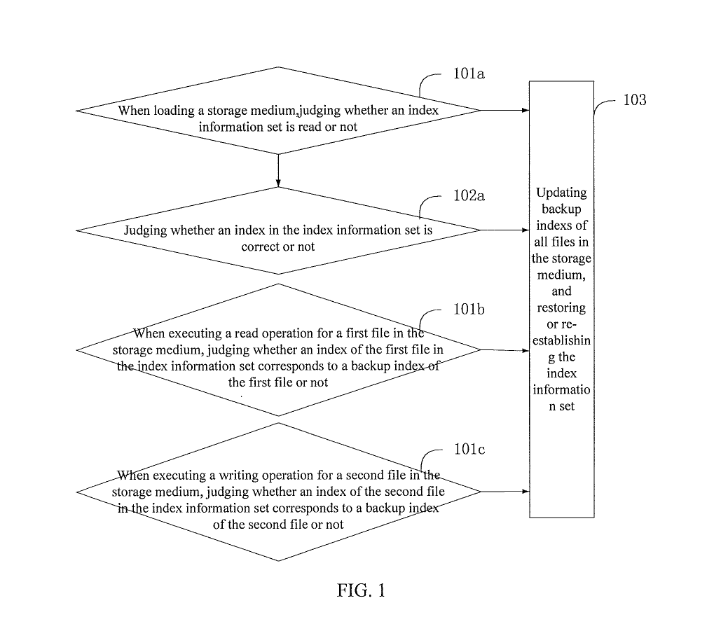

A first embodiment of the present invention provides a method for restoring system file indexes. Please refer to FIG. 1, the method for restoring system file indexes comprises steps in the following:

step 101a, when a storage medium is loaded, judging whether an index information set is read or not, if no, executing step 103, if yes, executing a step 102a;

step 102a, judging indexes in the index information set is correct or not, if no, executing a step 103;

step 101b, when executing a read operation for a first file in the storage medium, judging whether an index of the first file in the index information set corresponds to a backup index in the first file or not, if no, executing the step 103;

step 101c, when executing a read operation for a second file in the storage medium, judging whether an index of the second file in the index information set corresponds to a backup index of the second file or not, if no, executing the step 103;

step 103, updating the backup indexes of all files in the storage medium, and restoring or re-establishing the index information set.

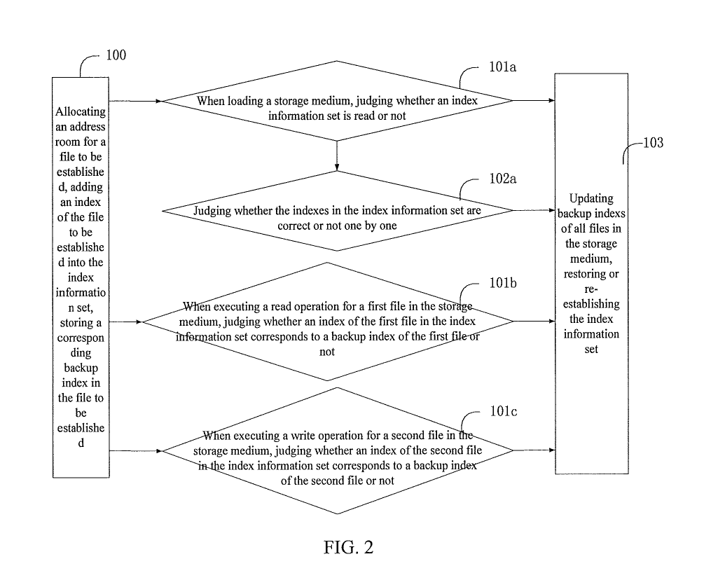

Preferably, as shown in FIG. 2, the method for restoring system file indexes comprises a step 100 before each of the step 101a, the step 101b, and the step 101c:

step 100, allocating an address room for a file to be established, adding an index of the file to be established into the index information set, and storing a corresponding backup index in the file to be established.

For one example, when a hard disk is loaded, the index information set is read firstly; if the index information set has been read, judging whether indexes in the index information set are correct or not. When it is judged that an index in the index information set is incorrect, the backup indexes of all files in the storage medium are uploaded, and the index information set is restored or re-established.

For another example, a file is established firstly, an address room is allocated (from 000000 to 004H5) for the file to be established (a file 3), an index of the file to be established (the file 3) is added into the index information set, a corresponding backup index is stored in the file to be established (the file 3); when a read operation is executed for the file 3, if an index of the file 3 in the index information set doesn't correspond to a backup index in the file 3, the backup indexes of all files in the storage medium is updated, and the index information set is restored or re-established.

In the embodiment of the present invention, the backup indexes of all files in the storage medium is updated and the index information set is restored or re-established when the storage medium is loaded and the index information set is not read, or when the storage medium is loaded and an index in the index information set is judged to be incorrect, or when a read operation is executed for the file in the storage medium, and an index of the file in the index information set doesn't correspond to a backup file in the file, or when a write operation is executed for the file in the storage medium, and an index of the file in the index information set doesn't correspond to a backup index in the file. Thus, a deficiency of repeated restart without recording is overcome.

### Embodiment II

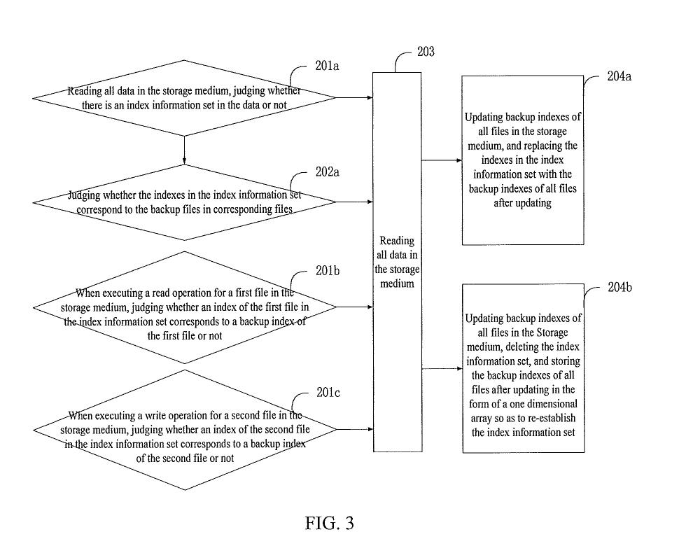

A second embodiment of the present invention provides a method for restoring system file indexes. Please refer to FIG. 3, the method for restoring system file indexes comprises:

step 201a, reading all data in the storage medium, and judging whether there exist the index information set in the data or not; if no, executing a step 203, if yes, executing a step 202a;

step 202a, judging whether the indexes in the index information set correspond to backup indexes in their corresponding files or not one by one, if no, executing the step 203;

step 201b, when executing a read operation for a first file in the storage medium, judging whether an index of the first file in the index information set corresponds to a backup index in the first file or not, if no, executing the step 203;

step 201c, when executing a writing operation for a second file in the storage medium, judging whether an index of the second file in the index information set corresponds to a backup index in the second file or not, if no, executing the step 203;

step 203, reading all data in the storage medium;

step 204a, updating the backup indexes of all files in the storage medium, and replacing the indexes in the index information set with the backup indexes of all files after updating.

For example, when loading a hard disk, traversing data in the hard disk; if the index information set exists, judging whether indexes in the index information set corresponds to the backup indexes in corresponding files or not, if an index in the index information set doesn't correspond to its backup index in a corresponding file, reading all data in the storage medium, updating the backup indexes of all files in the storage medium, and updating and replacing the indexes in the index information set with the backup indexes of all files after updating.

step 204b, updating the backup indexes of all files in the storage medium, deleting the index information set, and storing the backup indexes of all files after updating in the form of a one-dimensional array so as to re-establish the index information set.

For example, when executing a read operation for a file 3, judging whether an index of the file 3 in the index information set corresponds to a backup index in the file 3 or not, when the index of the file 3 in the index information set doesn't correspond to the backup index in the file 3, reading all data in the storage medium, updating the backup indexes of all files in the storage medium, deleting the index information set, and storing the backup indexes of all files after updating in the form of a one-dimensional array so as to re-establish the index information set.

Wherein the step 201a is a further detailed step for specifying the step 101a in FIG. 1; the step 202a is a further detailed step for specifying the step 102a in FIG. 1; when the step 103 in FIG. 1 is updating the backup indexes of all files in the storage medium and restoring the index information set, the step 103 comprises the step 203 and the step 204a in this embodiment; when the step 103 is updating the backup indexes of all files in the storage medium and re-establishing the index information set, the step 103 comprises the step 203 and the step 204b in this embodiment.

In the embodiment of the present invention, when the storage medium is loaded and the index information set is not read, or when the storage medium is loaded and an index in the index information set is judged to be incorrect, or when a read operation is executed for the file in the storage medium and an index of the file in the index information set doesn't correspond to a backup index in the file, or when a writing operation is executed for the file in the storage medium and an index of the file in the index information set doesn't correspond to a backup index in the file, all data in the storage medium is read, the backup indexes of all files in the storage medium are updated, and the indexes in the index information set are replaced with the backup indexes of all files after updating, or the backup indexes of all files in the storage medium are updated, the index information set is deleted, and the backup indexes of all files after updating are stored in the form of one-dimensional array so as to re-establish the index information set. Thus, a deficiency of repeated restarts without recording is overcome.

### Embodiment III

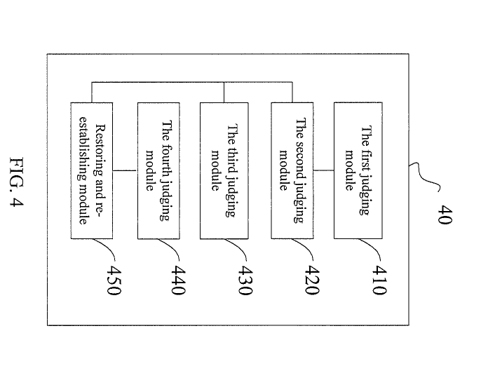

A third embodiment of the present invention provides a device for restoring system file indexes. As shown in FIG. 4, the device 40 for restoring system file index comprises a first judging module 410, a detecting module 420, a second judging module 430, a third judging module 440, and a restoring module 450.

The first judging module 410 is configured for judging whether an index information set is read or not when a storage medium is loaded;

the second judging module 420 is configured for judging whether an index in the index information set is correct or not;

the third judging module 430 is configured for judging whether an index of a first file in the index information set corresponds to a backup index in the first file or not when executing a read operation for the first file in the storage medium;

the fourth judging module 440 is configured for judging whether an index of a second file in the index information set corresponds to a backup index in the second file or not when executing a writing operation for the second file in the storage medium;

the restoring and re-establishing module 450 is configured for updating backup indexes of all files in the storage medium, and restoring or re-establishing the index information set.

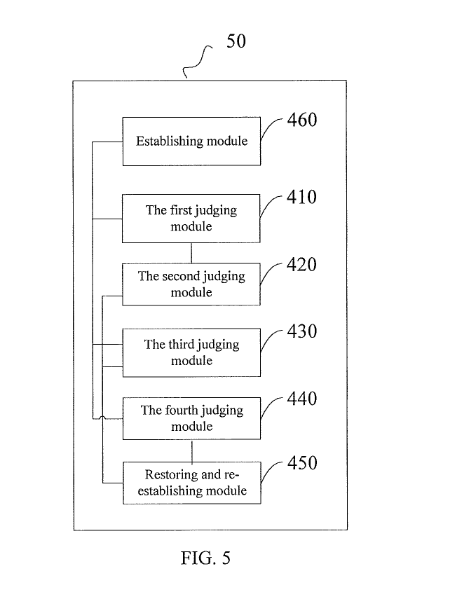

Preferably, as shown in FIG. 5, the device 50 for restoring system file indexes further comprises:

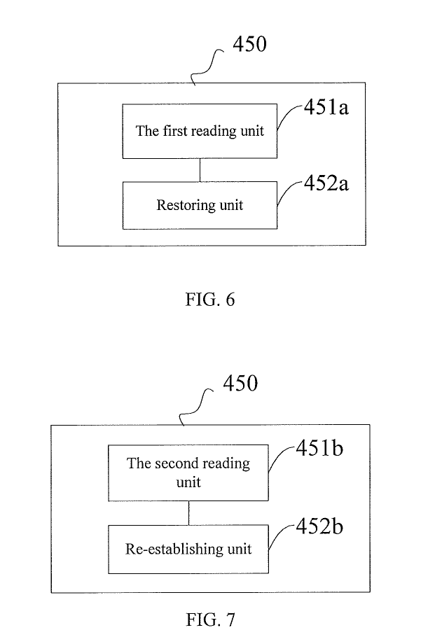

an establishing module 460, which is configured for allocating an address room for a file to be established, adding an index of the file to be established into the index information set, and storing a corresponding backup index into the file to be established.

Wherein, as shown in FIG. 6, when the restoring and re-establishing module 450 restores the index information set, the restoring and re-establishing module 450 comprises:

a first reading unit 450a, which is configured for reading all data in the storage medium;

a restoring unit 452a, which is configured for updating all backup indexes of all files in the storage medium, and updating, and replacing the indexes in the index information set with the backup indexes of all files after update;

Wherein, as shown in FIG. 7, when the restoring and re-establishing module 450 re-establishes the index information set, the restoring and re-establishing module 450 comprises:

a second reading unit 451b, which is configured for reading all data in the storage medium;

a re-establishing unit 452b, which is configured for updating the backup indexes of all files in the storage medium, deleting the index information set, and storing the backup indexes of all files after update in the form of one dimensional array so as to re-establish the index information set.

In this embodiment of the present invention, g backup indexes of all files in the storage medium is updated and the index information set is restored or re-established when the storage medium is loaded and the index information set is not read, or when the storage medium is loaded and the indexes in the index information set are judged to be incorrect, or when a read operation is executed for the file in the storage medium, and an index of the file in the index information set doesn't correspond to the backup file in the file, or when a writing operation is executed for the file in the storage medium, and the index of the file in the index information set doesn't correspond to the backup index in the file. Thus, a deficiency of repeated restarts without recording is overcome.

Serial numbers of aforesaid embodiments of the present invention are used for description merely, rather than representing superiority and inferiority of the embodiments.

Those skilled in the art should understand that a part or all of the procedures for implementing the aforementioned embodiments can be accomplished by hardware, or by using a program to instruct relevant hardware, the program can be stored in a computer readable storage medium, the above-mentioned storage medium mentioned can be a ROM (Read Only Memory), a magnetic disk, an optical disk, and so on.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A method for restoring system file index, comprising:
step A. when a storage medium is loaded, judging whether an index information set is read or not, if no, executing a step E, if yes, executing a step B;
step B. judging whether an index in the index information set is correct or not, if no, executing the step E;
step C. when executing a read operation for a first file in the storage medium, judging whether an index of the first file in the index information set corresponds to a backup index in the first file or not, if no, executing the step E;
step D. when executing a writing operation for a second file in the storage medium, judging whether an index of the second file in the index information set corresponds to a backup index in the second file or not, if no, executing the step E;
step E. updating backup indexes of all files in the storage medium, and restoring or re-establishing the index information set.

2. The method according to claim 1, further comprising:
before each of the step A, the step C, and the step D, allocating an address room for a file to be established, adding an index of the file to be established into the index information set, and storing a corresponding backup index into the file to be established.

3. The method according to claim 1, wherein when the step E is updating the backup indexes of all files in the storage medium and restoring the index information set, the step E comprises:
reading all data in the storage medium;
updating backup indexes of all files in the storage medium, and replacing the indexes in the index information set with the backup indexes of all files after updating;
when the step E is updating backup the indexes of all files in the storage medium and re-establishing the index information set, the step E comprises:
reading all data in the storage medium;
updating the backup indexes of all files in the storage medium, deleting the index information set, and storing the backup indexes of all files after updating in the form of a one-dimensional array to re-establish the index information set.

4. The method according to claim 1, wherein judging whether the indexes in the index information set are correct or not comprises:
judging whether the indexes in the index information set correspond to the backup indexes of corresponding files or not one by one.

5. The method according to claim 1, wherein judging whether the index information set is read or not comprises:
reading all data in the storage medium, and judging whether there is the index information index in the data or not.

6. A device for restoring system file index, wherein the device comprises:
a first judging module configured for judging whether an index information set is read or not when a storage medium is loaded;
a second judging module configured for judging whether an index in the index information set is correct or not;
a third judging module configured for judging whether an index of a first file in the index information set corresponds to a backup index in the first file or not when executing a read operation for the first file in the storage medium;
a fourth judging module configured for judging whether an index of a second file in the index information set corresponds to a backup index in the second file or not when executing a write operation for the second file in the storage medium;
a restoring and re-establishing module configured for updating backup indexes of all files in the storage medium, and restoring or re-establishing the index information set.

7. The device according to claim 6, wherein the device further comprises:
an establishing module configured for allocating an address room for a file to be established, adding an index of the file to be established into the index information set, and storing a corresponding backup index into the file to be established.

8. The device according to claim 6, wherein, when the restoring and re-establishing module restores the index information set, the restoring and re-establishing module comprises:
a first reading unit configured for reading all data in the storage medium;
a restoring unit configured for updating all backup indexes of all files in the storage medium, and updating, and replacing the indexes in the index information set with the backup indexes of all files after updating;
when the restoring and re-establishing module re-establishes the index information set, the restoring and re-establishing module comprises:
a second reading unit configured for reading all data in the storage medium;
a re-establishing unit configured for updating the backup indexes of all files in the storage medium, deleting the index information set, and storing the backup indexes of all files after updating in the form of a one dimensional array so as to re-establish the index information set.

9. The device according to claim 6, wherein the second judging module judges whether the indexes in the index information set are correct or not by:
judging whether the indexes in the index information set correspond to the backup indexes in corresponding files or not one by one.

10. The device according to claim 6, wherein the first judging module judges whether the index information set is read or not by:
reading all data in the storage medium, and judging whether there exist the index information set in the data or not.
